(19) United States
(12) Patent Application Publication
(10) Pub. No.: US 2003/0225638 A1
(43) Pub. Date: Dec. 4, 2003

(54) Method for outsourcing accounting functions over the internet; using an integrated system between the bank account information and the accounting records

(76) Inventor: Antonio F. Secola, Guaynabo, PR (US)

Correspondence Address: Antonio F. Secola, Villas de Tintillo, A Street, No. 14,, Guaynabo, PR, 00966, US

(21) Appl. No.: 10/114,444

(22) Filed: May 28, 2002

(51) Int. Cl. G06F 17/60

(52) U.S. Cl. 705/30

(57) ABSTRACT

A System to outsource accounting functions over the Internet system integrates the functions of a company's accounting, data processing and payroll departments, the Audit, TAX and MIS consultants, hardware, and software updating, banks reports and mail-telephone communications. The present invention liberates management and other personnel from day-to-day supervision, training, and repetitive tasks; also of keeping up-to-date and installing new tax laws, labor laws, new software, hardware. It offers consulting services in almost every business aspect.

### BACKGROUND OF THE INVENTION

1. Field of the Invention

The present invention relates generally to online services and, more particularly, to an online accounting method for outsourcing accounting services.

2. Discussion of the Background

Today, self-employed professionals and growing companies need to find new ways to increase sales, cut costs and improve productivity. Yet with limited time and resources, owners often find themselves engaged in the administrative details of running the business, rather than focusing on the more critical issues of the company.

Outsourcing of services is a way to enable owners to get to the heart of their business. For example, by contracting an outside provider for handling and managing the accounting functions, an owner can obtain an immediate greater level of expertise, improve productivity, and gain greater flexibility in its operations.

3. Comparison with Prior Art

Traditional Accounting Software—Cost effective accounting software like Peach Tree and QuickBooks are well known and may be considered “prior art”. These types of software can be easily managed by accountants. Some of the advantages of the present invention over the prior art are that:

1. An accountant is not needed to effectively maximize the use of the system. To properly use PeachTree or QuickBooks the owner or its employee needs to learn the software plus know the accounting basics. This invention was developed with non-accountants in mind, who have limited time to spend on administrative burdens. It is by far the simplest solution for handling a company's day-to-day needs.

2. The invention focuses on the services or the use of a software, not the software itself The invention allows management to make informed decisions based on the services rendered, e.g. data entry, processing payments and payroll, presenting and maintaining accurate and timely reports, etc. The invented methodology permits an effective communication channel to receive and follow the user's instructions. Accordingly, management can focus their time and energy, on growing the business while the rest can be effectively delegated.

3. The user need not worry about the typical problems with traditional accounting software. The user can stop worrying about having the latest software version, backing up their files, getting training, hiring or getting a MIS support contract, or maintaining his accounting software up and running The methodology of the present invention covers all these needs.

Online Accounting Software—Nowadays accounting software can be accessed and used over the Internet for a monthly rent and it may be considered “prior art”. This type of service is commonly referred to Application Service Provider (ASP), and the most commonly known are e-Peach Tree and NetLedger. These ASPs provide a great solution for outsourcing accounting software's MIS needs. It also allows the benefit of having the data maintained and stored in a scalable data management software, e.g. ORACLE, Microsoft SQL 7, etc. However, working with these systems is basically the same as using the traditional accounting software like MAS 90 or QuickBooks, except that they are on-line. Therefore, since these ASPs basically provide an on-line accounting software, one particular 0 problem is that the client still needs to learn how to use them, not to mention getting trained and/or knowing the accounting basics. In addition, they will still be using valuable time and money in data entry and/or processing. In other words, the prior art offers an accounting software, we offer outsourcing services that can be requested or instructed using our ASP invention.

An advantage of this software invention is that the client will have the same benefits as outsourcing their MIS function using an ASP without paying for using the software. They only pay for the actual services rendered (e.g. checks prepared, invoices posted, etc.). Because it is a full service provider of accounting functions PLUS an ASP at the same time, it can save the client and it's personnel, time and training costs, both in MIS and accounting matters. At the same time, they will benefit from on-line software that has a scalable database software tool (Microsoft SQL), and that is ready to grow with them.

On-line banking systems—Banking services over the Internet can also be considered “prior art”. However banking systems are great for consumers but certainly limited for business clients which are more complex. For businesses, the banks will provide certain tools and training but the client still needs to process everything and then transmit the instructions to the bank. On comparison, with our invention the client does nothing, we process everything and transmit the instructions directly to the bank following the client's instructions. This invention complements and fulfills all those on-line banking limitations. For example, a bank may have a software or a tool to process direct deposits for payroll payments. However, the client needs to compute gross wages, regulatory and voluntary deductions, generate a file and transmit the file to the bank (assuming the employee has been trained to do all this and the employer has purchased the necessary computer and communication equipment to transmit the electronic file). With our invention, based on the instructions given by management using our methodology, we compute gross wages, we compute regulatory and voluntary deductions, we generate the electronic file and we transmit the file. Besides informing the Bank Balances and processing payments (checks and electronic) which is basically what the prior art includes, the invention also produces an on-line Reconciliation of Bank Balance; processes the Payroll; prepares Payroll Checks and Returns; presents your Unpaid Invoices; segregates Payments by Payee; monitors Professional Service Withholdings; provides Many Different Authority Levels; provides Image handling of Invoices and Bills; reports Deposits by Customer, unlimited; follows up on Receivables; maintains Complete Records of your Payees, Customers and Employees; produces the Accounting Financial Reports; and Changes Password On-line, among many other things.

Traditional Reconciling Software—Currently any accounting software will include a module to reconcile the bank account. Furthermore, you can purchase software specifically designed to reconcile two sets of information. However, our invention includes the intervention of a third party (us) who will perform the reconciliation on behalf of the client and report the results over the Internet. With our inventions our clients basically do nothing as compared to the subject prior art in which the user has to organize both sets of information, import and maintain both sets and then reconcile them to detect differences. Our invention also provides an organized method to clear exceptions and or differences over the Internet at the client's convenience. Thus, our invention requires no employees, no licenses, and no integration from the client's side.

Traditional Outsourcing Accounting Services—Outsourcing using our invention can substitute a prior art, the traditional employee or service provider. Previously, the Companies had to have separate accounting and data processing departments; CPA, TAX and MIS Consultants; all needed to prepare Financial and Government reports, processing payments on accounts payable, following up on accounts receivable, processing payroll checks, etc. Unfortunately, this is very expensive and even with all this personnel, the information is generally produced late and too old to use. Also management had to fully depend on its personnel in order to figure out what is going on, having the on-going risk that those employees may resign, steal the information or lack the technical capacity. On the contrary, our invention combines the service and software needed to easily manage the business with minimum or no employees, and can be understood by non-accountants, non-computer specialists, thus it can be sued directly by management reducing the above mentioned risk. The information needed for decision-making is at the most one day old.

Therefore, it can be appreciated that there exists a continuing need for accurate, up-to-dated financial information and businesses can benefit from outsourcing non-core functions and by using an ASP model to reduce accounting and MIS related costs. Our invention provides these means by being accessible over the Internet, being easy to understand and use, multilingual, dynamic, and interactive. Our web site, (URL www.alchavo.com) uses the Internet to offer a variety of easy-to-follow Web pages to allow a user to effectively manage and control its business at any time, from anywhere and serves as an efficient communication channel between a server operator and its customers in order to handle non-core day-to-day accounting functions for medium and small size businesses. In this regard, the present invention substantially fulfills this need.

### SUMMARY OF THE INVENTION

It is an object of the present invention to provide:

1 an online accounting system and method that enables its users to have more time available to increase revenues and profitability and to lessen the time devoted to administrative tasks. This is done, without losing control of their business, nor freedom to act on their own, FREE of software cost or personnel training;

2 a system and method which gives access to all of a user's financial data in one organized and integrated system, 24 hours a day 7 days a week, through the Internet;

3 a support staff which enables the users to stay in compliance with local payroll laws and regulations;

4 a system and method of online accounting which enables the user to make informed and accurate decisions with custom designed, timely, and accurate financial information available;

5 a data management system that is cost effective, secure, reliable and easy to use;

6 a method where the client's bank balances are reconciled and compared daily with the company's accounting records to analyze its cash (liquidity) needs or surplus;

7 a method where all the data, corrections, decisions and approvals are made by the client or its designated person, through a web page, reconfirmed on-line by the administrator office; with no chance of papers being lost, changed or destroyed and this immediately acted upon and the files updated;

8 a method to outsource or delegate the processing of non-core day to day business transactions, e.g. accounts payable payments, processing payroll, etc. all in an integrated framework and reconciled daily with your bank account.

Another object of the present invention is to provide a data basis which enables a company to grow in informatics, adding modules to perform Job Costing, Time & Billing, Statistical and Planning Studies, etc. using the same system.

Accordingly, it is a primary object of the present invention is to overcome disadvantages of the prior art, which had to pay and sustain a disintegrated number of functions. The prior art had the need for a multiplicity of tasks, personnel, internal controls, offices, equipment, software expenses, etc., the required presence of specialists among others and the inability of an authorized person to access the daily updated information from anywhere, anytime. The invention is one system capable of outsourcing all these multiple functions

The System itself, both as to its construction and its mode of operation, will be best understood, and additional objects and advantages thereof will become apparent from the following detailed description taken in conjunction with the accompanying drawings.

When the word “invention” is used in this specification, the word “invention” includes “inventions”, that is, the plural of “invention”. By stating “invention”, the Applicant does not in any way admit that the present application does not include more than one patent ably and non-obviously distinct invention, and Applicant maintains that the present application may include more than one patent ably and non-obviously distinct invention. The Applicant hereby asserts, that the disclosure of the present application may include more than one invention, and, in the event that there is more than one invention, that these inventions may be patent able and non-obvious one with respect to the other.

Furthermore, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWINGS

Our invention can be organized into six (6) integrated modules that complement each other. The enclosed flowcharts are organized following the same structure of six (6) modules. The modules are:

Module 1—Cash Summary

Module 2—Receivable and Deposits

Module 3—Payments

Module 4—Payroll

Module 5—Financial Reporting

Module 6—Customer Service

A summary of the FIGS. follow:

FIG. 1 is a block diagram of the CASH SUMMARY MODULE of the present invention;

FIG. 2 is a block diagram of the RECEIVABLES AND DEPOSITS MODULE of the invention.

FIG. 3 is a block diagram of the PAYMENTS MODULE of the invention.

FIG. 4 is a block diagram of the PAYROLL MODULE of the invention.

FIG. 5 is a block diagram of the FINANCIAL REPORTS MODULE of the invention.

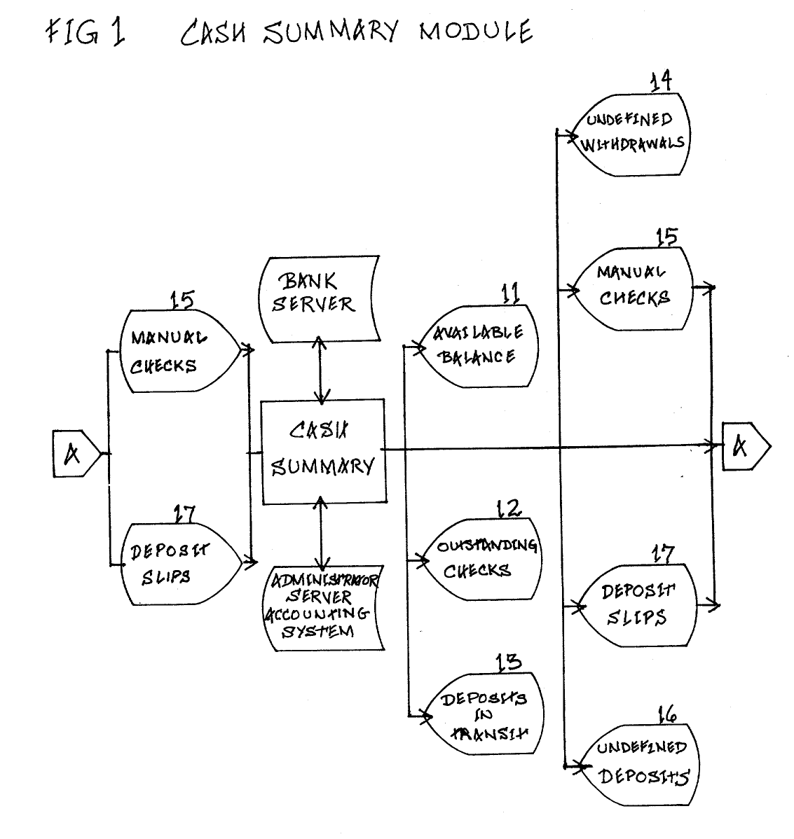

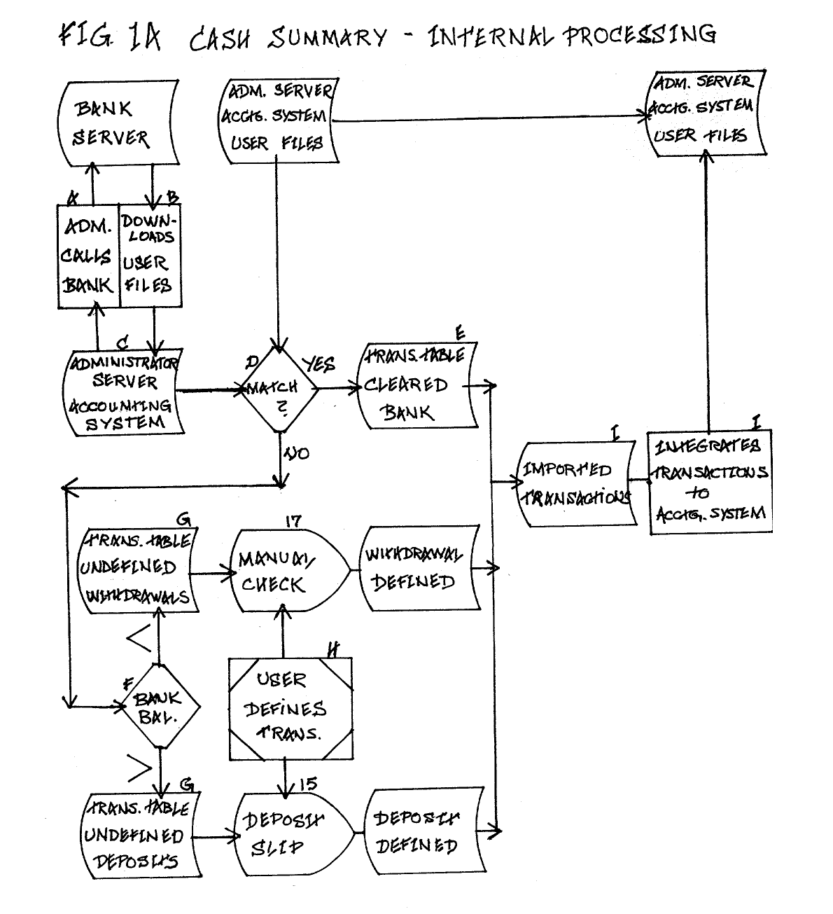

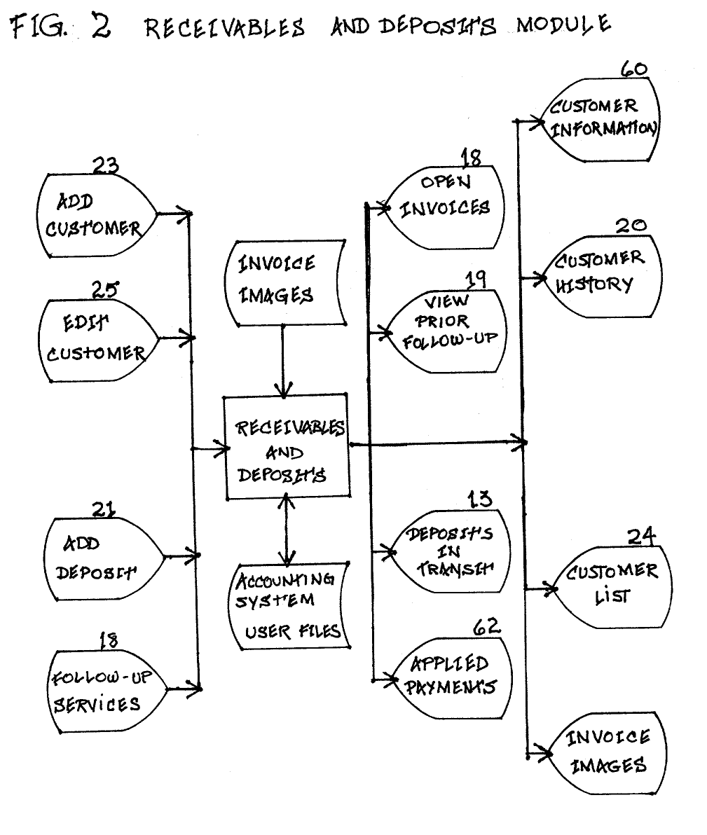

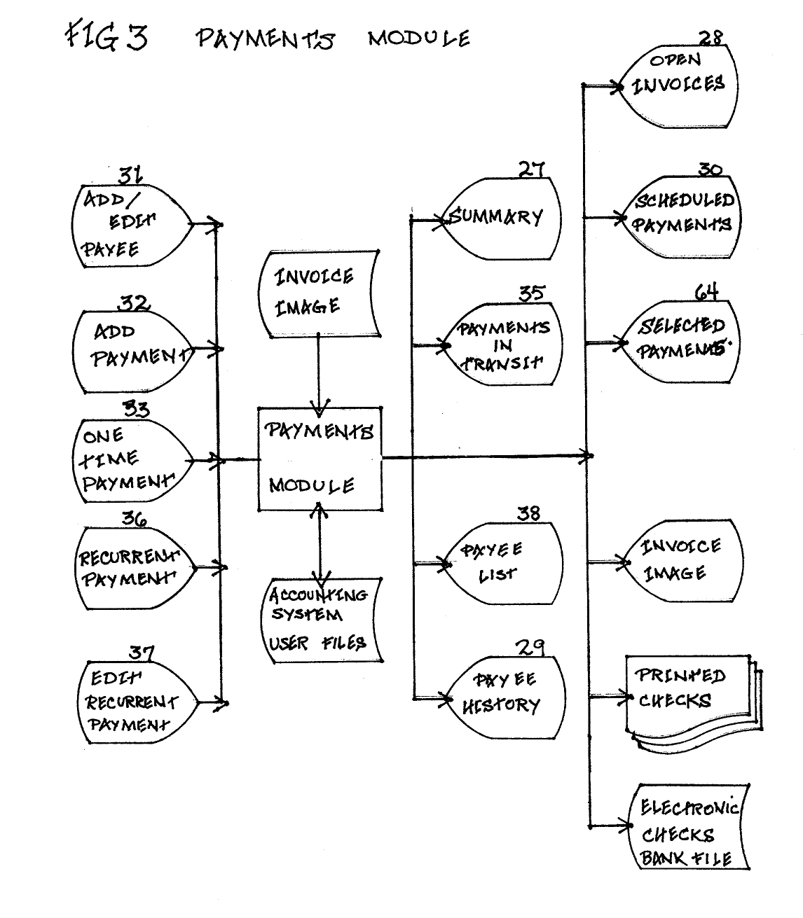

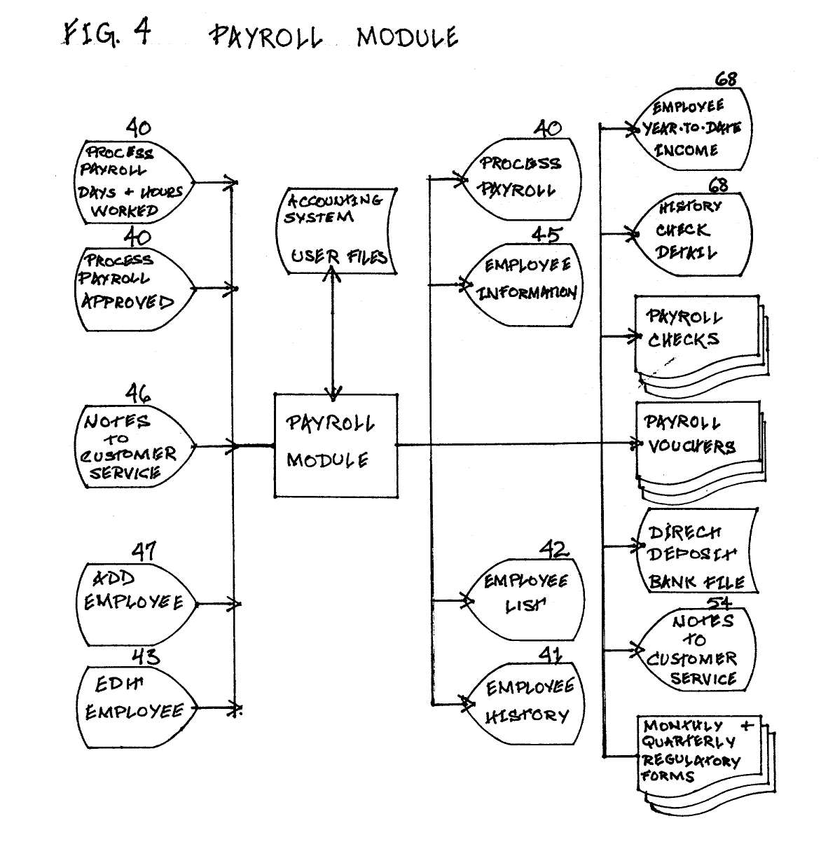

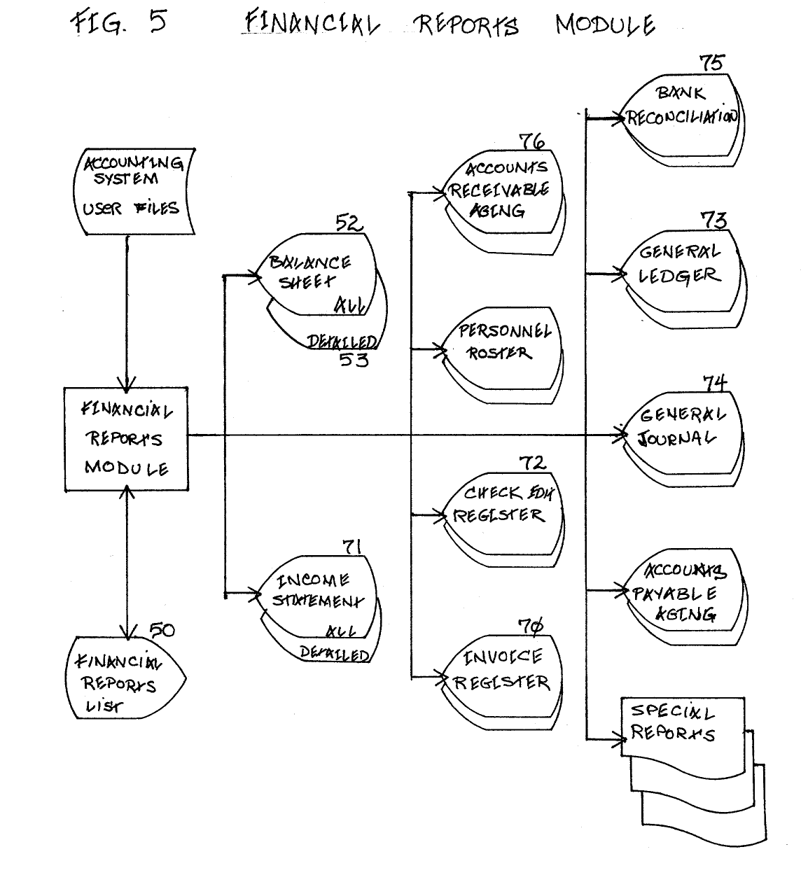

### DETAILED DESCRIPTION OF THE INVENTION

Our invention can be organized into six (6) integrated modules that complement each other. The enclosed description of the invention is organized following the same structure of six (6) modules. The modules are:

Module 1 - Cash Summary
Module 2 - Receivable and Deposits
Module 3 - Payments
Module 4 - Payroll
Module 5 - Financial Reporting
Module 6 - Customer Service

### Module 1—Cash Summary Module (“CSM”)

General Description

This module allows the user to review a daily reconciliation of his bank balance that will help him make day-to-day informed decisions. The user may access his daily bank balance and a reconciliation of his truly disposable, expendable balance, all organized in one place. With this daily reconciliation, the user will always know what checks and/or deposits are outstanding and pending to clear the bank. This is crucial when deciding which invoices to pay.

How it Actually Works:

1 During the morning a server at the inventor's site calls a server at a bank. (Reference to Screens #______)

2 The call has a script that enters the inventor's password and follows some logical steps to automatically download a file from the bank's server. (Reference to Screens #______)

3 The electronic file includes all the inventor's client's accounts information, including prior day's bank account balances and transactions in a format known as BAI2. (Reference to Screens #______)

4 A proprietary internally developed software, compares the information downloaded from the banks to the client's accounting records kept at the inventor's server. (Reference to Screens#______)

5 If the information matches an “outstanding item” it means that the transaction issued from the accounting system “cleared” the bank and accordingly it is no longer outstanding. These transactions are imported into the accounting system to be marked as “cleared” in the new reconciliation and accordingly it will no longer appear as outstanding. (Reference to Screens #______)

6 If the information does not match to an “outstanding item” it would mean that the client or the bank originated a transaction that has not been recorded in the inventor's accounting server. (Reference to Screens #______)

7 Since the transaction was originated by the client or the bank, these transactions are stored in tables until they are explained by the client and or the bank. This methodology allows us to daily reconcile the client's bank account while maintaining the flexibility that the clients need to process transactions on their own from time to time. (Reference to Screens #______)

9 It also allows the client an effective and efficient method to explain such transactions at any time over the Internet. (Reference to Screens #______)

10 Once these transactions are explained, they are imported into the accounting system which is in itself integrated to the Payments, Cash Summary, Receivable and Deposits and Financial Reporting Modules. (Reference to Screens #______)

11 Once the daily reconciliation is done it is presented on the Internet for the client to review and analyze. (Reference to Screens #______)

In addition, the CSM allows the user to quickly analyze his liquidity situation by reviewing, in one screen, his current bank balances, his open invoices and rescheduled payments, his uncollected receivables, and his estimated future payroll commitment. By comparing all this information in one organized place, the user may decide which invoices to pay or hold or which clients to follow up on their uncollected balance, in order to meet his payroll commitments.

Furthermore, once each account is reconciled, the administrator may send the user an e-mail with all the relevant information, including his bank balance and the transactions that have cleared the bank since the administrator's last reconciliation. By providing this proactive service the user may receive e-mails over his cellular phone or at his electronic organizer and review any returned deposits or overdraft balances before his payees and/or bank officials contact him.

Through the present invention the administrator can therefore reconcile on a daily basis his clients bank accounts, which they can access over the internet for informed daily decisions while at the same time provide an organized and integrated means to explain transactions processed by the bank but still not recorded in the accounting system.

### WEB PAGES Description

Cash Summary (Reference to Screens #11)

The Available Balance Screen presents a reconciliation between the bank balance and the book balance. Both the Bank balance and the Book balance could have reconciling items, thus both balances are reconciled to an adjusted balance, if necessary. Reconciliation may be done daily, weekly or monthly. To view the last reconciliation posted select the Bank ID from the drop down and click on GO. In the same screen, the client will find usefull information about your payables, receivables and payroll.

Outstanding Checks (Reference to Screen #12)

In the Outstanding Checks screen the client can review a list of all their checks processed and issued through our system that have not cleared the bank as of the last reconciliation date. In the detailed description the list is updated and populated every time we reconcile the client's bank account. The list does NOT include manual checks that they may have originated without using the system.

Deposits in Transit (Reference to Screen #13)

In the Deposits in Transit screen the client can review a list of all deposits entered into our system that have not cleared the bank as of the last reconciliation date. In the detailed description, this list is updated and populated every time the administrator reconciles the user's bank account.

Undefined Withdrawals (Reference to Screen #14)

In the Undefined Withdrawals Screen the client can review a list of all transactions that decreased their bank balance that are not reflected in their books. In order to properly account for these withdrawals, the client must complete either a Manual Check form or an Adjustment form. In the detailed description, if the Manual Check pertains to a particular invoice that has already been entered into our system and it is open or scheduled, the client is responsible for specifying so in the purpose field as “WARNING PAID OPEN OR SCHEDULED INVOICE”

Undefined Withdrawals: Manual Checks (Reference to Screen #15)

Manual Checks are checks that have cleared the particular bank that were NOT originated or processed through our system. To properly account for these checks in the detailed description of this invention, the user needs to provide additional information about each particular payment, e.g. Payee ID, Purpose and Amount. If the payment pertains to an invoice that had already been entered in our system (this information is available in the Payee History Screen #______), the client is responsible for specifying so (write “WARNING PAID OPEN INVOICE”) in the Purpose field of the entry form.

Undefined Withdrawals: Confirm Withdrawal

Once the client have successfully defined a Manual Check or an Undefined Withdrawal and pressed on Save, a confirmation page will appear to provide them with immediate feedback that the information they entered has been successfully transmitted and to notify the proper course of action that will follow.

Undefined Deposits (Reference to Screen #16+17)

In the Undefined Deposits Screen the client can review a list of all transactions that increased their bank balance that are not reflected in their books since the required information has not been posted in our system. In order to properly account for these deposits, the client must complete a Deposit Slip form. If the deposit pertains to a particular invoice that has already been entered into our system, the client is responsible for entering the EXACT invoice number (available in the Customer History screen #______).

Timing and Frequency of Reconciliation

The timing and frequency of the client's bank reconciliation depends on the time the underlying information is furnished by the client's bank. In the detailed description, if the user's bank account is maintained at an Affiliated Bank and they have authorized electronic access to the information, the reconciliation is done and posted every working day. However, if the bank has not updated their records early enough on any given working day (this would vary by user), the administrator may not be able to reconcile that day.

If a Non-Affiliated bank, timing and frequency will depend on unique arrangements.

Defined Deposit Confirmation Once the client have successfully defined an Undefined Deposit and pressed on Save, a confirmation page will appear to provide them with immediate feedback that the information they entered has been successfully transmitted and to notify the proper course of action that will follow.

### Module 2—Receivables and Deposits (“RDM”)

General Description

In here, the user may view an organized summary of all his outstanding uncollected invoices segregated by each customer. The user may review scanned images of invoices sent and he can also access his customer's history of transactions for review and analysis.

In addition, in the RDM, the user may also request that the administrator follows up on his uncollected invoices. Based on the user's request, the administrator may call, send a fax or email to the customer on behalf of the user. After the administrator contacts the customer, he will report back to the user the results of his attempt.

Further, in the RDM, the user may review a list of all his customers and access their relevant information online, including their telephone number, address, e-mail, contact person, etc. In addition, the user may add new customers or edit existing ones online.

The user may also record daily deposits made and segregate them by customer and invoice paid. This will help the user keep track of outstanding deposits and customer paying tendencies.

### WEB PAGES Description

Receivables: Open Invoices (Reference to Screens #18) In the Open

Invoices Screen the client will access a list of all the unpaid invoices that they have sent to their clients and that we have entered into our system. From this screen they may request that we Follow up or access a history of payments pertaining to a particular invoice.

Follow Up (Reference to Screens #18)

On the Follow Up Screen the client will find a list of all Open Invoices from their customers that have been entered and posted into our system. They may request that we follow up on any of the invoices for which an image has been stored. We will post the results of our attempt through the View Prior Follow Ups icon. To provide the Follow Up service we must have the pertinent information already in our database, e.g. to request that we call, we must already have the customer phone number.

Follow Up History (Reference to Screens #19)

The Follow Up History Screen presents a history of the results of prior follow up attempts that we have done on the client's behalf for that particular invoice.

Receivables History (Reference to Screens #20)

In the Customer History Screen the client may review past transactions with said Customer sorted by invoice date. They may review unpaid balances of each invoice issued to that particular Customer plus a history of prior payments made, if any. The client may also change the date range based on their needs and the information they are looking for.

Applied Payments

If an invoice has been paid with more than one payment (e.g. various checks over a period of time) the client may review a list of such payments in the Various Payments Screen. Relevant information about each payment is detailed.

Add Deposit (Reference to Screens #21)

One Deposit Slip must be filled for each deposit that the client makes at your bank. A deposit may be comprised of more than one receipt. The total of the receipts must equal the total of the deposit slip. To apply receipts against invoices already entered in our system, the client must enter the EXACT invoice number as presented in the Customer History Screen in the blank provided. If the invoice number is not found in our system we will automatically recognize a new invoice issued to that Customer.

Confirm Deposit

Once the client has successfully completed a Deposit Slip and pressed Add, a confirmation page will appear to provide the client with immediate feedback that the information you entered has been successfully transmitted and to notify the proper course of action that will follow.

Add Customer #23

Through the Add Customer Screen the client may add a New Customer and its related information. The only item that may not be changed once it has been created is the Customer ID, thus a consistent naming convention should be followed, e.g. customer name. Certain fields are always required. To complete the Add function, the client must press on the Add command icon at the bottom of the Screen. An on-line confirmation will appear on screen.

Add Customer Confirmation

Once the client have successfully Edited a Customer Information and pressed on Edit, a confirmation page will appear to provide them with immediate feedback that the information they edited has been successfully transmitted and to notify the proper course of action that will follow.

Customer List (Reference to Screens

At the Customer List Screen the client may review a list of all their customers on record at the current date. Some relevant information about each customer is also presented, e.g. telephone numbers. Through this page they may access the Customer History Screen or the Customer Information Screen of each particular customer. They may also originate an internal communication to request a service regarding a particular customer.

Customer Information

On the Customer Information screen the client may review all the relevant information previously entered and maintained in our database about a particular Customer ID. From this screen they may access the Edit Customer Screen to add, modify or delete any of the information presented.

Edit Customer (Reference to Screens #25)

Through the Edit Customer Screen the client may add, edit or modify any information that we (or they) have previously entered into our system. The only item that may not be changed once it has been created is the Customer ID. Any changes made will update our database immediately. Thus, the original information is automatically deleted/erased. To complete the Edit function, they must press on the Edit command icon at the bottom of the Screen. An on-line confirmation will appear on screen.

Confirm Edit of Customer

Once the client have successfully edited or modified the Customer Information and pressed the Edit command icon, a confirmation page will appear to provide them with immediate feedback that the information they entered has been successfully transmitted and to notify the proper course of action that will follow.

### Module 3—Payments (“PM”)

General Description

The Invention provides a two click process to complete a payment instruction. The first click selects the invoice and the second click approves and schedules the payment.

In the PM, the user may review a list of all open invoices segregated by each payee. The user may also view a scanned image of the actual invoice received by him and the user may select and schedule which, when, how much, and from which bank account, each invoice will be paid. A history of the payments and invoices to/from each payee may also be accessed for review and analysis.

If a user needs to make a payment to a payee that has not been set up in the system's records, the user may add both the payee and the payment online. In addition, for payments that repeat themselves with a certain frequency, the user may set them up as a recurring payment. Recurring payments can be set up for different frequencies and for fixed or variable amounts.

Further, in the PM, the user may review a list of all his payees and access their relevant information online, including their telephone number, address, e-mail, contact-person, among others. In addition, the user may add new payees or edit existing ones online.

In the detailed description, all payments can be processed by check or electronically.

### WEB PAGES Description

Summary (Reference to Screens #27)

The Payments Summary Screen presents the Total Balance Due to each Payee at the current date, sorted by Payee Name. Total Balance Due represents all unpaid invoices that are owed to that particular Payee that have been received and posted into our system. The detailed invoices that comprise the total due to a particular payee are segregated between Open Invoices (see Open Invoices Screen) and Scheduled Payments (see Scheduled Payments Screen).

Open Invoices (Reference to Screens #28)

Open Invoices are unpaid invoices (or portions thereof) received and entered into our system for which a payment has not been scheduled. The client may review an image of the invoice, if available, by pressing on the “lupa” icon. To schedule a payment the client must specify the amount to pay, the process date, and the bank account from which the disbursement will be made. A summary of your selection will be presented in the Selected Payments Screen for final approval before scheduling.

Review Selected Payments

The Selected Payments Screen summarizes the selection the client has done for final review before approval. Once approved, payments will be scheduled on-line and automatically. If the User has no authority to approve payments (e.g. sign checks) a batch with a unique reference number will be saved for final approval by an authorized user. In that scenario, an e-mail will be automatically generated to inform the authorized user that a selection has been pending final approval from him/her.

Payee History (Reference to Screens #29)

In the Payee History Screen the client may review past transactions with said payee sorted by invoice date. They may review unpaid balances of each invoice received from that particular payee plus a history of prior payments made, if any. They may also change the date range based on their needs and the information they are looking for.

Scheduled Payments (Reference to Screens #30)

In the Schedule Payments Screen the client may access a list of all the payments that have been scheduled for processing. They may view and change the status of each scheduled payment as either release or hold. We will prepare or process a single check or electronic payment per each Payee ID including all invoices with status of “release” payable to said Payee ID. Changes of status must be made at least three days in advance. Once they have made your selection they must press the Save command icon.

Add Payee (Reference to Screens #31)

A Payee ID must be assigned to each invoice posted and to each payment scheduled. In the Add Payee Screen the client may enter all the relevant information about each particular new Payee. Certain fields will be required based on the information they select, e.g. if the Payee is subject to retention, then the EIN is required. To request electronic payments they must provide the Route and Transit Number of the Payee bank, and the Payee and their bank must consent to such payment methodology in writing.

Add Payment (Reference to Screens#32)

To add a new payment the client has two options, to schedule the payment as a One Time Payment or to set up a Recurring Payment. One Time Payments should ONLY be used if the particular invoice and/or payment are NOT included in the Open Invoice Screen or the Scheduled Payments Screen. If the subject payment repeats itself in a particular frequency or amount they may set it up as a Recurring Payment. Through this screen they may also access a list of all Recurring Payments previously stored.

One Time Payment (Reference to Screens #33)

One Time Payments must ONLY be used to schedule payments against invoices that have NOT been entered in our system. Accordingly, before setting up a One Time Payment the client is responsible for ascertaining that said invoices have not been previously posted by reviewing the Open Invoice Screen, Scheduled Payments Screen and Payee History Screen. Otherwise, they could be exposed to a duplicate posting or payment. One time payments are reflected in our system within two working days from receipt.

Recurrent Payments (Reference to Screens #36)

The option to set-up a Recurring Payment should be used for those payments that repeat themselves in a particular pattern (e.g. monthly, amount, etc.). These payments can vary in frequency and amount. If the amount is variable, the pre-authorized payment option must be selected. Any recurrent payments that the client sets up will be posted and reflected five (5) business days in advance.

Edit Recurring Payments (Reference to Screens #37)

Through the Edit Recurring Payments screen the client may add, edit or modify any information that we (or they) have previously entered into our system, except the Recurring Payment ID and the Starting Date. Any changes made will update our database on-line and immediately. Thus, the original information is automatically deleted/erased. To complete the Edit function, they must press on the Edit command icon at the bottom of the Screen. An on-line confirmation will be presented.

Payee List (Reference to Screens #38)

The client may view a list of all their Payees on record in the Payee List Screen. The list is organized in alphabetical order based on the Payee official name. In addition, they may access a particular Payee to view its set-up information or history of past transactions.

Edit Payee Information

Through the Edit Payee Information the client may add, edit or modify any information that we (or they) have previously entered into our system. The only item that may not be changed once it has been created is the Payee ID. Any changes made will update our database on-line and immediately. Thus, the original information is automatically deleted/erased. To complete the Edit function, they must press on the Edit command icon at the bottom of the Screen. An on-line confirmation will appear on screen.

Invoice Image (Reference to Screens #34)

E-mail Notes (Reference to Screens #46)

Payments in Transit (Reference to Screens #35)

### Module 4—Payroll (“PRM”)

General Description

Here the user enters the payroll period end date and the number of hours worked per employee in that period.

The user may segregate the employees by hourly and salaried employees. Hours worked may be segregated by vacation, sick, regular, and overtime, among others. In addition, the user may set up different payroll frequencies for different employees. For example, executive employees can be paid once a month, while hourly employees can be paid on a weekly basis. A user may also add a new employee to his payroll or edit the information of existing ones online.

Further, in the PRM the user may review a list of all his employees and their year to date compensation history. He may also view employee information including addresses, telephone, and compensation rates.

The system administrator will prepare and forward to the user the payroll checks or direct deposit files and related vouchers, including a detail of all the regulatory withholdings and voluntary deductions made. The checks and vouchers will also reflect the number of vacation and sick days each employee has accumulated.

The administrator may also prepare all regulatory monthly and quarterly informative regulatory forms.

### WEB PAGES Description

Payroll (Reference to Screens #40)

To commence the Payroll Process, the client must enter the Start Date, End Date and Pay Date and then select the Frequency. The Screen will show all ACTIVE employees pertaining to the subject Frequency. For salaried employees they need to enter the number of Vacation and/or Sick hours taken, if any. ACTIVE salaried employees are always paid the same amount. For Hourly employees they must enter all hours worked including holidays, sick days, etc. Only hourly employees with hours entered will get paid.

Process Payroll Confirmation

Once the client have successfully submitted their payroll information and pressed on Process Payroll a confirmation page will appear to provide them with immediate feedback that the information they entered has been successfully transmitted and to notify the proper course of action that will follow.

Payroll In Process

Once the client has entered and submitted their payroll information we will begin processing it. During said period, they will not be able to access the Process Payroll Screen. Once we have completed the process, we will post an Edit Register for them to review and approve. Any changes requested must be submitted in writing using a print out of the Edit Register. Once the final Edit Register is approved, the client must authorize us to complete the process by pressing on the Approve Payroll command icon.

Payroll History Reference to Screens

In the Employee History Screen the client may review past payments made to that particular employee. They may review gross and net payments done, hours worked in that particular pay period and the check number used. They may access a detailed summary of each payroll payment made by pressing on top of the Check Number.

Add Employee (Reference to Screens #47)

The client may add a new employee through the Add Employee Screen. Certain fields are always required and others will be required depending on the information that they entered. To request direct deposit they must provide the Route and Transit Number of the Employee bank, and the Employee and their bank must consent to such payment methodology in writing. The PR State Tax information should be based on the Form 499 completed/signed by the employee and maintained by each employer.

Employee List (Reference to Screens #42)

At the Employee List Screen the client may review a list of all their employees on record at the current date. Some relevant information about each employee is also presented, e.g. status as inactive or active. Through this page they may access the Employee History Screen or the Employee Information Screen of each particular employee. The client may also originate an internal communication to request a service regarding a particular employee.

Edit Employee Information (Reference to Screens #43)

History Check Detail (Reference to Screens #44)

Employee Information (Reference to Screens #45)

### Module 5—Financial Reports (“FRM”)

General Description

The enables the user to access and/or download all his financial reports directly. All financial reports can be tailor made to fit the user's need and may be prepared on a monthly or other basis.

Standard reports may include: balance sheet, income statement, accounts receivable aging, accounts payable aging, payroll register, check register, invoice register, bank account reconciliation, general ledger, general journal, among others.

### WEB PAGES Description

Financial Reports (Reference to Screens #50) In the Financial Reports Screen the client may review a list of all the financial reports that they have requested, e.g. balance sheet, purchase journal, etc. they may access the actual reports available by pressing on the particular report. A new screen will appear with all available reports and a brief description. They may then access, view, download or save any of the available reports.

Financial Reports Available Reference to Screens #51)

In the Available Reports Screen the client will be able to access, view, download or save any of the available reports. They will see a date when each was created and posted plus a brief description, if necessary.

### Module 6—Customer Service (“CSM”)

General Description

The Inventor provides a trained staff which is a reliable source to handle common business day-to-day requests about a user's information. The administrator may respond to all requests in writing within a pre-agreed time frame of receipt to coordinate efforts and fulfill the user's needs.

Further, through the CSM, the user may request additional complementary services provided outside the basic online modules such as:

Human Resources Management, Tax Planning and Preparation, MIS Support, Review of Internal Controls, and General Consulting, Projections, and Business Plans.

Customer Service (Reference to Screens #52)

Change User Password (Reference to Screens #53)

E-mail Note to Customer Service (Reference to Screens #54)

In the detailed description, the basic modules are described. Nonetheless, other modules may be possible without departing from the spirit and scope of this invention.

All of the patents, patent applications, and publications recited herein, and in the Declaration attached hereto, if any, are hereby incorporated by reference as if set forth in their entirety herein. The components disclosed in the various patents, patent applications, and publications, disclosed or incorporated by reference herein may be used in the detailed description of the present invention, as well as equivalents thereof.

All, or substantially all, of the components and methods of the various detailed descriptions may be used with at least one detailed description or all of the detailed description, if more than one detailed descriptions is presented herein.

The details in the patents, patent applications, and publications may be considered to be incorporable at applicant's option, into the claims during prosecution as further limitations in the claims to patent ably distinguish any amended claims from any applied prior art.

Thus, the invention has been shown and described the invention: Method for Outsourcing Accounting Functions over the Internet; using an Integrated System between the Bank Account Information and the Accounting Records, which fulfills all the objects and advantages sought therefore. Although only a few exemplary detailed descriptions of this invention have been detailed above, those skilled in the art will readily appreciate that many modifications are possible in the exemplary detailed descriptions without materially departing from the novel teachings and advantages of this invention. For instance, the data bases of the present invention are designed for Job Costing, Time & Billing, Statistical and Planning Studies. Accordingly, all such modifications are intended to be included within the scope of this invention as defined in the following claims. In the claims, means-plus-function clauses are intended to cover the structures described herein as performing the recited function and not only structural equivalents but also equivalent structures.

What I claim as my invention is:

1. A method for managing third party accounting needs online, comprising:
(a) providing to the user, a System which can be accessed and processed from anywhere at anytime through the Internet;
(b) providing instant interactive communication between the administrator of said System and the users;
(c) presenting information on a Web site having a plurality of modules, wherein one of the modules presents a daily reconciliation between accounting records and bank information over the Internet;
(d) saving all of a user's historical accounting information on a database, which can be used for statistical reports, projections and comparisons; and
(e) automatically reconciling a third party's bank account to its accounting records on a daily basis.

2. The method of claim 1, wherein said automatic daily reconciliation is achieved by:
(a) generating an automatic call from the administrator's server, that downloads all the user's accounts file from the bank's server, including prior day's bank account balances and transactions;
(b) comparing accounting data with bank information; and
(c) presenting the results on the Internet.

3. The method of claim 1, further comprising the step of taking into consideration transactions not recorded nor originated from the Accounting System that manages these transactions, but that were identified as part of the said daily bank reconciliation.

4. The method of claim 3, wherein said transactions are stored in temporary tables until the user of the method or his bank explains said transactions.

5. The method of claim 4 where the user or his bank explains and clear transactions that have not been recorded on the user's accounting records and that were identified as part of the daily bank reconciliation, the invention also includes the design and functionality of the process needed to receive the explanation.

6. The method of claim 5, further comprising the step of integrating all said transactions into the daily bank reconciliation process.

7. The method of claim 6, further comprising the step of presenting the bank account reconciliation, a summary total of the outstanding open accounts payable, a summary total of the last payroll paid, and a summary total of the uncollected accounts receivable information all in the same screen.

8. The method of claim 7, wherein all information provided on screen is up-to-date.

9. The method of claim 1, wherein said modules comprise:
(a) A payroll module;
(b) A financial reports module;
(c) A cash summary module;
(d) An accounts receivable module;
(e) A payments module; and
(f) A customer services module

10. The method of claim 9, wherein said financial reports module provides user defined reports available online.

11. The method of claim wherein all the System's documentation, the screens, reports, instructions, etc. are completely multilingual.

12. The method of claim further compromising the step of integrating all said transactions into the Accounting System affecting, as appropriate, all other integrated and related modules of financial reporting, bank reconciliation, accounts receivables, accounts payable and payroll.
